(19) United States
(12) Patent Application Publication
(10) Pub. No.: US 2005/0276732 A1
(43) Pub. Date: Dec. 15, 2005

(54) Catalytic converter and method of making the same

(75) Inventor: Takatoshi Saito, Yokohama (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/150,093

(22) Filed: Jun. 13, 2005

(30) Foreign Application Priority Data
Jun. 14, 2004 (JP) 2004-175063

(51) Int. Cl. B01D 53/34

(52) U.S. Cl. 422/179; 422/177; 29/890

(57) ABSTRACT

A catalytic converter comprising a catalyst carrier, a casing accommodating therewithin the catalyst carrier, a catalyst mat interposed between the catalyst carrier and the casing, and an annular stopper at an end of the catalyst carrier, wherein the catalyst mat has an extension portion compressed between the casing and the stopper for holding the stopper in place within the casing. A method of making a catalytic converter is also provided.

### BACKGROUND OF THE INVENTION

The present invention relates to a catalytic converter having a catalyst carrier held stably within a casing while carrying a catalyst, and a method of making such a catalytic converter.

A catalytic converter is disposed in an exhaust system of an engine with a view to reducing toxic components such as CO and HC contained in exhaust gases, as disclosed in Japanese Utility Model Publication No. 5-47333 and Unexamined Japanese Patent Publication No. 9-273417. The catalytic converter typically has a honeycomb-shaped monolithic catalyst carrier held within a casing that is to be connected to an exhaust pipe. On the surface of the catalyst carrier is coated a catalytic material such as platinum. that purifies the toxic components. In Japanese Utility Model Publication No. 5-47333, it is disclosed to cover the outer periphery of the catalyst carrier by means of a buffer member (mat) and interpose a washer between the casing and each of opposite front-to-rear end portions of the catalyst carrier and the buffer, which front-to-rear end portions are opposed in a gas flow direction in which gas flows through the catalyst carrier.

### SUMMARY OF THE INVENTION

In recent years, in order to cope with the strict exhaust gas regulation, a catalyst carrier of a high density and thin wall, i.e., of 900 cell/inch² in cell density and 50 μm in wall thickness has been put into a practical use. Such a catalyst carrier of a high density and thin wall is necessarily decreased in the crash strength. For this reason, there is a difficulty in holding the catalyst carrier stably within the casing. Further, in case the catalyst carrier is held by using a buffer member made from a metal wire net and washers as disclosed in Japanese Utility Model Publication No. 5-47333, there is a possibility that the surface pressure acting on the catalyst carrier becomes excessively high to exceed the crash strength.

It is accordingly an object of the present invention to provide a catalytic converter which is free from the above-noted problem inherent in the prior art device.

It is another object of the present invention to provide a method of making a catalytic converter of the foregoing character.

To achieve the above object, there is provided according to an aspect of the present invention a catalytic converter comprising a catalyst carrier, a casing accommodating therewithin the catalyst carrier, a catalyst mat interposed between the catalyst carrier and the casing, and an annular stopper at an end of the catalyst carrier, wherein the catalyst mat has an extension portion compressed between the casing and the stopper for holding the stopper in place.

According to another aspect of the present invention, there is provided a method of making a catalytic converter including a catalyst carrier, a casing accommodating therewithin the catalyst carrier, a catalyst mat interposed between the catalyst carrier and the casing, and an annular stopper at an end of the catalyst carrier, the method comprising winding the catalyst mat around the catalyst carrier and the annular stopper that are disposed coaxially to produce an intermediate assembly, inserting the intermediate assembly into a metal pipe, and forming the metal pipe into the casing accommodating therewithin the catalyst carrier, the stopper and the catalyst mat, wherein the forming includes making a portion of the metal pipe positioned around the stopper reduce in diameter to form a reduced diameter portion of the casing, compressing a portion of the catalyst mat between the reduced diameter portion and the stopper and holding the stopper in place within the casing.

### BRIEF DESCRIPTION OF THE DRAWINGS

FIG. 1 is a sectional view of a catalytic converter according to a first embodiment of the present invention;

FIG. 2 is an enlarged view of a portion II of FIG. 1;

FIG. 3 is a view for illustrating a process of making the catalytic converter of FIG. 1;

FIG. 4 is a fragmentary sectional view showing a stopper of a catalytic converter according to a second embodiment of the present invention;

FIG. 5 is a sectional view of a catalytic converter according to a third embodiment of the present invention; and

FIG. 6 is a sectional view of a catalytic converter according to a fourth embodiment of the present invention.

### DESCRIPTION OF THE PREFERRED EMBODIMENTS

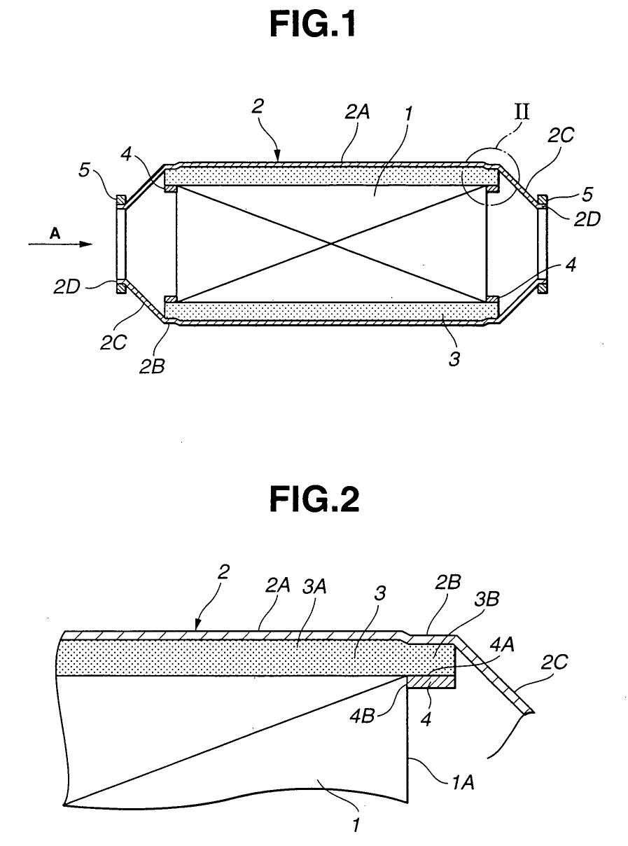

Referring first to FIGS. 1 and 2, a catalytic converter according to a first embodiment of the present invention will be described. As is well known, the catalytic converter is disposed in a vehicle exhaust system. The catalytic converter includes, as major components, catalyst carrier 1 carrying thereon a catalyst, casing 2 encasing or accommodating therewithin catalyst carrier 1, catalyst mat 3 interposed between an inner circumferential surface of casing 2 and an outer circumferential surface of catalyst carrier 1, and two annular stoppers 4 disposed coaxial with catalyst carrier 1 and adjacent opposite axial ends thereof that are opposed in a gas flow direction “A” in which gas flows through catalyst carrier 1.

Catalyst carrier 1, as is well known, is formed of a monolithic, honeycomb-shaped ceramic body having on the surface thereof a coating of a catalytic material such as platinum. Catalyst carrier 1 has a generally uniform outer peripheral shape along the gas flow direction “A” and typically has a cylindrical shape having an axis extending in the gas flow direction “A” as in this embodiment. Catalyst carrier 1 is preferably of a high density and thin wall type, i.e., of the type having a cell density of 900 cell/inch² or more and a wall thickness of 50 μm or less so as to have a high catalytic purification ability.

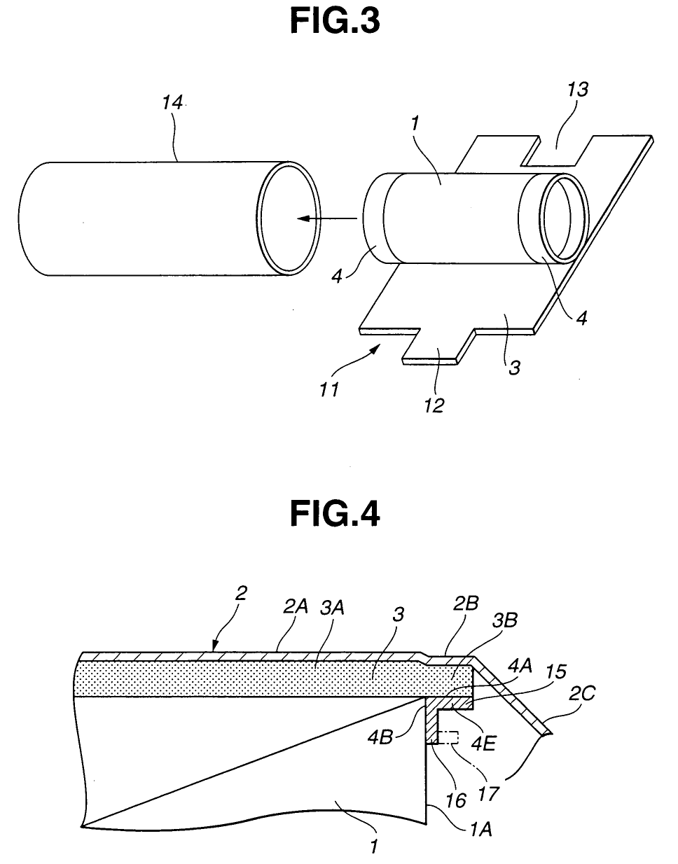

Casing 2, as will be described later, is formed by spinning for making tubular metal pipe 14 (refer to FIG. 3) partially reduce in diameter. Casing 2 has, as a principal portion, cylindrical portion 2A that surrounds an outer circumferential periphery of catalyst carrier 1. Casing further has opposite open end portions 2D to which flanges 5 are fixedly attached. Flanges 5 are used for fixedly attaching thereto exhaust pipes (not shown). Open end portion 2D is smaller in inner diameter than cylindrical portion 2A so that casing 2 has tapered portion 2C between open end portion 2D and cylindrical portion 2A. Tapered portion 2C connects smoothly between cylindrical portion 2A and open end portion 2D so as not to obstruct a flow of exhaust gas, i.e., tapered portion 2C has a truncated cone shape so as to decrease in diameter gradually from cylindrical portion 2A to open end portion 2D.

Stopper 4 is in the form of a circular ring and made of metal so as to be excellent in strength. Stopper 4 has a function of supporting catalyst carrier 1 so as to prevent axial movement of catalyst carrier 1 relative to casing 2. Outer circumferential surface 4A of stopper 4 has nearly the same shape and diameter as that of catalyst carrier 1 so that stopper 4 extends smoothly continuously from carrier 1 without any substantial step therebetween. Catalyst-facing surfaces 4B of stoppers 4 are disposed so as to prevent axial movement of catalyst carrier 1, particularly in the gas flow direction “A”, i.e., so as to support or engage respective end faces 1A of catalyst carrier 1. In the meantime, while in this embodiment, catalyst-facing surfaces 4B are configured so as to directly support end faces 1A of catalyst carrier 1, they may be configured so as to support end faces 1A of catalyst carrier 1 indirectly by interposing a portion of catalyst mat 3 between catalyst-facing surface 4B and end face 1A of catalyst carrier 1 as shown in FIG. 6.

Catalyst mat 3 is a non-expansion mat formed from alumina fibre and having a low expansion rate. Catalyst mat 3 has mat extension portion 3B extending along the gas flow direction “A” so as to protrude from catalyst carrier 1. Mat extension portion 3B is held in a compressed state between outer circumferential surface 4A of stopper 4 and the inner circumferential surface of casing 2. Namely, mat extension portion 3B of catalyst mat 3 is partially compressed strongly so as to generate a remarkably or considerably higher surface pressure as compared with mat main body portion 3A held between catalyst carrier 1 and casing 2. Accordingly, stopper 4 can be held stably on casing 2 by way of mat extension portion 3B.

A portion of casing 2 at the joint between cylindrical portion 2A and tapered portion 2C, i.e., reduced diameter portion 2B that holds mat extension portion 3B in a compressed state together with stopper 4 is reduced in the outer diameter by a predetermined amount as compared with cylindrical portion 2A surrounding catalyst carrier 1. Accordingly, a space (gap) between stopper 4 and reduced diameter portion 2B in which mat extension portion 3B is interposed is smaller than a space between catalyst carrier 1 and cylindrical portion 2A of casing 2 such that mat extension portion 3B is partially compressed strongly as described above.

For holding stopper 4 stably, it is necessitated for a strong surface pressure to act between stopper 4 and mat extension portion 3B. However, since mat extension portion 3B is protruded from catalyst carrier 1 along the gas flow direction “A”, it becomes possible to allow a large surface pressure to act only on mat extension portion 3B and thereby reduce the surface pressure acting between catalyst carrier 1 and mat main body portion 3A sufficiently. Accordingly, catalyst carrier 1 of a high density and thin wall type having a low crash strength can be employed. In this manner, by a simple structure using catalyst mat 3 and stopper 4, catalyst carrier 1 of a high density and thin wall type can be held stably within casing 2.

FIG. 3 illustrates a process of making a catalytic converter. First, in a state of catalyst carrier 1 and stopper 4 being arranged coaxially, catalyst mat 3 of a uniform thickness is wound around catalyst carrier 1 and stopper 4 so as to cover the outer peripheries thereof, thereby producing an intermediate assembly 11. In the meantime, in order that catalyst mat 3 can be held in such a wound-around state provisionally, catalyst mat 3 is, for example, formed with protruded portion 12 and recessed portion 13 that are fittingly engageable with each other. Secondly, intermediate assembly 11 is inserted or pressed into cylindrical metal pipe 14 that is to be formed into casing 2. In order that such an insertion or pressing operation can be performed easily, the outer diameter of stopper 4 is preferably sized so as to be equal to, as described above, or a little smaller (for example, by 2 mm or less) than that of catalyst carrier 1. Thirdly, metal pipe 14 is subjected to a spinning process, thereby forming reduced diameter portions 2B, tapered portions 2C and open end portions 2D and producing casing 2. To each open end portion 2D is attached flange 5 (refer to FIG. 1).

In this manner, metal pipe 14 in a state of having inserted thereinto intermediate assembly 11 in which catalyst mat 3 is wound around catalyst carrier 1 and stopper 4 is subjected to a diameter-reducing process such as spinning, thereby forming reduced diameter portions 2B that are positioned around respective stoppers 4, together with tapered portions 2C and open end portions 2D. By this, mat extension portion 3B interposed between reduced diameter portion 2B and stopper 4 is compressed strongly, thus causing a strong surface pressure to act between mat extension portion 3B and stopper 4 and thereby holding stopper 4 stably. In this manner, by utilizing a spinning process that is widely used for forming casing 2, catalyst carrier 1, stopper 4 and catalyst mat 3 can be assembled and held stably within casing 2 and its production can be attained quite with ease.

Further, since the surface pressure caused between catalyst mat 3 and catalyst carrier 1 can be reduced, whereas catalyst mat 3 can be held strongly between stopper 4 and casing 2, the requirement for the quality of catalyst mat 3 is mitigated and catalyst mat 3 that has a surface specific gravity of 1200 g/m² or less and is inexpensive can be used, thus making it possible to reduce the cost.

In the meantime, in this embodiment, reduced diameter portion 2B is reduced in diameter uniformly from cylindrical portion 2A and thereby equalize the surface pressure caused at mat extension portion 3B as shown in FIG. 2. However, this is not limitative but, reduced diameter portion 2B can be partially tapered as for example shown in FIG. 6 or entirely, i.e., tapered portion 2C may partially double as reduced diameter portion 2B.

FIG. 4 shows a catalytic converter according to a second embodiment. In this embodiment, stopper 4E, when observed in cross section, is bent nearly at right angles to have cylindrical wall portion 15 with outer circumferential surface 4A and radially inward flange portion 16 with catalyst-facing surface 4B. Stopper 4E thus has a nearly L-shaped section and has an excellent strength. Since stopper 4E in the second embodiment enables catalyst-facing surface 4B to be sized sufficiently large, it becomes possible to prevent movement of catalyst carrier 1 in the gas flow direction “A” assuredly, thus making it possible to improve the ability of holding catalyst carrier 1 in place. On the other hand, stopper 4 in the first embodiment, as compared with stopper 4E in the second embodiment, is smaller in catalyst-facing surface 4B, thus enabling catalyst carrier 1 to obtain a larger exhaust gas flowing area. Accordingly, an area by which the gas flowing passage of catalyst carrier 1 is closed by catalyst-facing surface 4B is reduced, thus making it possible to improve the conversion efficiency of the exhaust gas and reduce the back pressure.

In the meantime, in order to make higher the strength of stopper 4, radially inward flange portion 16 may be further bent at right angles so as to form inner cylindrical wall portion 17 positioned concentrically with cylindrical wall portion 15.

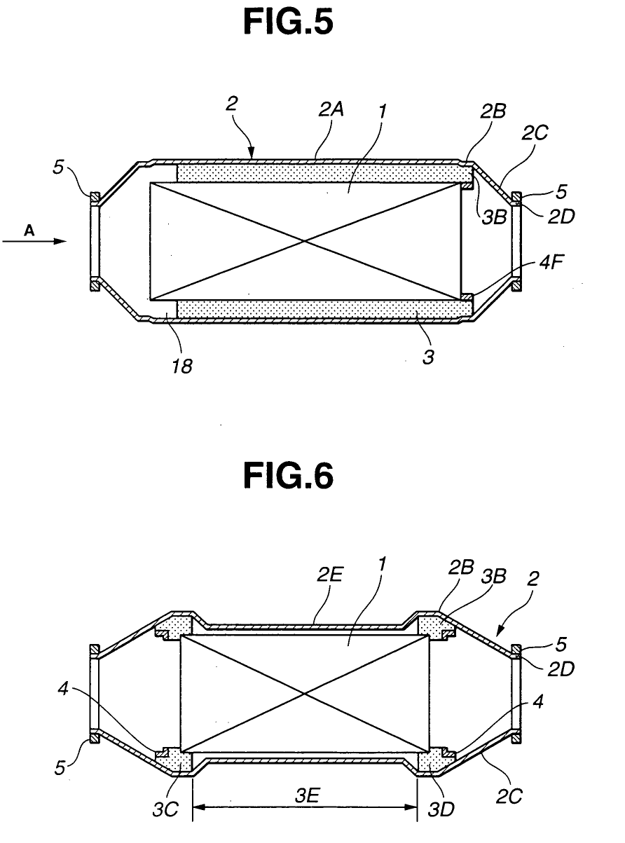

FIG. 5 shows a catalytic converter according to a third embodiment. In the third embodiment, only one stopper 4F is disposed on the downstream side or the rear end side with respect to the gas flow direction “A” and there is not provided any stopper at the upstream side or the front end side with respect to the gas flow direction “A”. By omitting the stopper on the upstream side of catalyst carrier 1, it becomes possible to reduce the overall length of casing 2 and thereby make casing 2 smaller in size. Furthermore, it becomes possible to reduce the number of constituent parts and attain an effect of reducing the weight and the cost.

Since the exhaust gas flows in the gas flow direction “A”, catalyst carrier 1 is subjected to a force that urges catalyst carrier 1 toward the downstream side. Against such a force, catalyst carrier 1 can be held stably by stopper 4F on the downstream side. In contrast to this, in case downstream side stopper 4F is omitted and there is provided in place thereof a stopper at a place 18 adjacent the downstream end, it is impossible to hold catalyst carrier 1 in place stably.

FIG. 6 shows a catalytic converter according to a fourth embodiment. In the fourth embodiment, the catalyst mat includes two separate mat sections 3C, 3D that are disposed so as to cover the outer circumferential periphery of catalyst carrier 1 only partially, i.e., provided only at and adjacent the upstream end and downstream end of catalyst carrier 1. Namely, there is not provided such a catalyst mat that covers the entire circumferential periphery of catalyst carrier 1 but there is provided a zone 3E between two mat sections 3c, 3D, in which zone there is not provided any catalyst mat. By this, the volume of the catalyst mat can be reduced considerably, thus making it possible to reduce the weight and cost. Particularly, the non-expansion mat using alumina fibre is quite expensive though suited for use in catalyst carrier 1 of a high density and thin wall type that is relatively lower in crash strength, an effect attained by the above-described omission of mat and reduction in cost is quite large.

Further, the cylindrical portion of casing 2 is partially reduced in diameter at portion 2E corresponding to zone 3E where the catalyst mat is not provided. By this, the catalytic converter can be further smaller in size.

Further, by forming mat sections 3C, 3D into a circular ring and joining each of them with stopper 4 so as to constitute an integral unit, a work for pressing intermediate produce 11 into a metal pipe can be dispensed with or can be done with ease and the freedom of design about the shape of casing 2 is increased.

From the foregoing, it will be understood that according to the present invention, a catalyst carrier can be stably retained within a casing by means of a simple structure using a catalyst mat covering an outer circumferential periphery of the catalyst carrier and a stopper having a catalyst-facing surface. The stopper is held or supported on the casing by way of a mat extension portion that is held in a compressed state between the stopper and the casing. For retaining the stopper stably, it is necessary to make a strong surface pressure act between the stopper and the mat extension portion. However, since the mat extension portions are protruded from the catalyst carrier along the gas flow direction, the stoppers can be held stably within the casing by causing a large surface pressure to act, of the catalyst mat, only on the mat extension portions, which large surface pressure never acts on the catalyst carrier. Accordingly, even a catalyst carrier of a high density and thin wall type for use in, for example, DPF (Diesel Particulate Filter), that is high in pressure loss and low in crash strength, can be held stably within the casing without deteriorating its function.

Further, it will be understood that according to the present invention the catalyst carrier, stoppers and catalyst mat can be assembled and installed in the casing so as to be held stably therewithin at the time of production of the casing by means of a spinning process that is widely used such that the catalytic converter can be produced quite with ease.

The entire contents of Japanese Patent

Applications P2004-175063 (filed Jun. 14, 2004) are incorporated herein by reference.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

1. A catalytic converter comprising:
a catalyst carrier;
a casing accommodating therewithin the catalyst carrier;
a catalyst mat interposed between the catalyst carrier and the casing; and
an annular stopper at an end of the catalyst carrier;
wherein the catalyst mat has an extension portion compressed between the casing and the stopper for holding the stopper in place within the casing.

2. A catalytic converter according to claim 1, wherein the stopper is nearly equal in an outer peripheral shape to the catalyst carrier, and wherein the casing is partially reduced in size so as to compress the extension portion of the catalyst mat between the casing and the stopper.

3. A catalytic converter according to claim 2, wherein the end of the catalyst carrier is a downstream end with respect to a gas flow direction in which gas flows through the catalyst carrier.

4. A catalytic converter according to claim 3, further comprising another annular stopper at an upstream end of the catalyst carrier, and wherein the catalyst mat includes another extension portion compressed between the casing and the other stopper for holding the other stopper in place within the casing.

5. A catalytic converter according to claim 4, wherein the casing comprises a cylindrical portion, tapered portions at respective axial ends of the cylindrical portion and reduced diameter portions between the cylindrical portion and the respective tapered portions, and wherein the casing is partially reduced in size at the reduced diameter portions to compress the extension portions of the catalyst mat between the reduced diameter portions of the casing and the stoppers.

6. A catalytic converter according to claim 5, wherein the catalyst carrier is cylindrical and wherein each of the stoppers has an outer diameter equal to or smaller than that of the catalyst carrier.

7. A catalytic converter according to claim 4, wherein the casing includes a cylindrical portion, open end portions of an inner diameter smaller than an outer diameter of the catalyst carrier, and tapered portions located between the cylindrical portion and the respective open end portions so as to decrease gradually in diameter toward the open end portions, and wherein the catalyst mat includes two separate mat sections disposed only at and adjacent the respective ends of the catalyst carrier.

8. A catalytic converter according to claim 7, wherein the cylindrical portion of the casing is partially reduced in diameter between end sections thereof at which the mat sections are disposed, respectively.

9. A catalytic converter comprising:
a monolithic catalyst carrier having opposite axial ends that are opposed in a gas flow direction in which gas flows therethrough;
a casing accommodating therewithin the catalyst carrier;
a catalyst mat interposed between an outer circumferential surface of the catalyst carrier and an inner circumferential surface of the casing; and
an annular stopper disposed at one of the axial ends of the catalyst carrier;
wherein the stopper has an outer circumferential surface nearly equal in shape to that of the catalyst carrier and a catalyst-facing surface facing the one axial end of the catalyst carrier to prevent axial movement of the catalyst carrier relative to the casing; and
wherein the catalyst mat has a mat extension portion protruded along the gas flow direction from the catalyst carrier, the mat extension portion being held in a compressed state between the outer circumferential surface of the stopper and the inner circumferential surface of the casing for holding the stopper in place within the casing.

10. A catalytic converter according to claim 9, wherein the casing has a smaller diameter portion, and wherein the mat extension portion of the catalyst mat is disposed between the smaller diameter portion of the casing and the stopper.

11. A catalytic converter according to claim 9, wherein the stopper has an outer diameter equal to or smaller than that of the catalyst carrier.

12. A catalytic converter according to claim 9, wherein the stopper is L-shaped in section and has a cylindrical wall portion formed with the outer circumferential surface and a radially inward flange portion formed with the catalyst-facing surface.

13. A catalytic converter according to claim 9, wherein the one axial end is a downstream end with respect to the gas flow direction, and wherein the stopper is provided only at the downstream end of the catalyst carrier.

14. A catalytic converter according to claim 9, further comprising another annular stopper at the other end of the catalyst carrier, and wherein the catalyst mat includes another mat extension portion compressed between the casing and the other stopper for holding the other stopper in place within the casing.

15. A catalytic converter according to claim 14, wherein the casing includes a cylindrical portion, open end portions of an inner diameter smaller than an outer diameter of the catalyst carrier, and tapered portions located between the cylindrical portion and the respective open end portions so as to decrease gradually in diameter toward the open end portions, wherein the catalyst mat includes two separate mat sections disposed only at and adjacent the respective ends of the catalyst carrier, and wherein the mat extension portions are compressed between the tapered portions of the casing and the stoppers, respectively.

16. A catalytic converter according to claim 15, wherein the cylindrical portion of the casing is partially reduced in diameter between end sections thereof at which the catalyst mat sections are disposed.

17. A method of making a catalytic converter including a catalyst carrier, a casing accommodating therewithin the catalyst carrier, a catalyst mat interposed between the catalyst carrier and the casing, and an annular stopper at an end of the catalyst carrier, the method comprising:
winding the catalyst mat around the catalyst carrier and the annular stopper that are disposed coaxially to produce an intermediate assembly;
inserting the intermediate assembly into a metal pipe; and
forming the metal pipe into the casing accommodating therewithin the catalyst carrier, the stopper and the catalyst mat;
wherein the forming includes making a portion of the metal pipe positioned around the stopper reduce in diameter to form a reduced diameter portion of the casing, compressing a portion of the catalyst mat between the reduced diameter portion of the casing and the stopper and holding the stopper in place within the casing.

18. A method according to claim 17, wherein the casing includes a cylindrical portion disposed around the catalyst carrier, open end portions of an inner diameter smaller than an outer diameter of the catalyst carrier, and tapered portions located between the cylindrical portion and the open end portions so as to decrease gradually in diameter toward the open end portions, and wherein the making comprises making a portion of the metal pipe to be formed into the cylindrical portion of the casing partially reduce in diameter.

19. A method according to claim 17, wherein the casing includes a cylindrical portion disposed around the catalyst carrier, open end portions of an inner diameter smaller than an outer diameter of the catalyst carrier, and tapered portions located between the cylindrical portion and the open end portions so as to decrease gradually in diameter toward the open end portions, and wherein the making comprises forming the tapered portions and allowing one of the tapered portions to partially function as the reduced diameter portion.

20. A method according to claim 17, wherein the making comprises spinning.
